(19) United States
(12) Patent Application Publication
(10) Pub. No.: US 2026/0199793 A1
(43) Pub. Date: Jul. 16, 2026

(54) SYSTEMS AND METHODS FOR ELECTRONIC GAME CONTROL AND GAME CONTROLLER CONFIGURATIONS WITH EMG SENSING AND USER IDENTIFICATION

(71) Applicant: Sony Interactive Entertainment INC., Tokyo (JP)

(72) Inventor: Jeffrey Stafford, Redwood City, CA (US)

(73) Assignee: Sony Interactive Entertainment INC., Tokyo (JP)

(21) Appl. No.: 19/016,945

(22) Filed: Jan. 10, 2025

(51) Int. Cl. A63F 13/79; A63F 13/212

(52) U.S. Cl. CPC A63F 13/79; A63F 13/212

(57) ABSTRACT

Systems, processes and device configurations are provided for electronic game control with electromyography (EMG) sensing and user identification. Embodiments include processes for receiving output from at least one EMG sensor and identifying a user profile for the user using the at least one EMG signal detected from the user. EMG signals may be detected by a one or more sensors, such as a wrist strap with sensors, to detect user signals. Embodiments include game controller configurations and systems for electronic game content presentation configured to update output of game elements and game features based on user detection. User profiles may be detected from user movements detected from at least one EMG sensor. Similarly, user profiles may be detected by comparing of the output of EMG sensors to recorded EMG sensor data for the user. Machine learning models are described for training and use to identify users from EMG signal.

### FIELD

The present disclosure is directed to systems and methods for electronic game control, game controller configurations and user identification, including electromyography (EMG) sensing of users, processing of game input controls and machine learning operations for characterizing EMG signals.

### BACKGROUND

Computer and console games often receive input from control devices to receive user controls. As device processing increases and game environments become more immersive, there is a desire for enhancement of content and customization of game interaction with users. For some gaming services, there is a desire to simplify user actions for customization of game content. For at least these reasons there is a need for improving devices and game control features for gaming and interactive systems.

### BRIEF SUMMARY OF THE EMBODIMENTS

Disclosed and described herein are systems, methods and configurations for electronic game control with electromyography (EMG) sensing and user identification. In one embodiment, a method includes receiving, by a device, output from at least one electromyography (EMG) sensor for a user of an electronic game, the output including at least one EMG signal detected from the user, and identifying, by the device, a user profile for the user using the at least one EMG signal detected from the user. The method also includes controlling, by the device, output of an electronic game presentation, wherein at least one game element of the electronic game is configured for output using the user profile.

In one embodiment, the output of the at least one EMG sensor includes electrical activity detected from a user wrist and associated with at least one of a hand movement and finger movement of a user.

In one embodiment, the output of the at least one EMG sensor includes electrical activity associated with user EMG data for at least one of a button press, directional pad input, analog stick motion, finger gesture, wrist motion, and controller movement.

In one embodiment, the user profile includes at least one of a user login, user profile data and user defined game setting.

In one embodiment, identifying a user profile includes outputting a prompt for a user movement, and detecting a user data signature in the output of the at least one EMG sensor in response to the prompt.

In one embodiment, identifying a user profile includes detecting a plurality of user movements in the output of the at least one EMG sensor, the plurality of user movements performed with a predefined sequence.

In one embodiment, identifying the user profile includes comparing of the output of the at least one EMG sensor to recorded EMG sensor data for the user.

In one embodiment, identifying the user profile detecting a user login for a game console using output of the at least one EMG sensor.

In one embodiment, controlling output of the at least one game element for electronic game presentation includes unlocking at least one of a game feature and game controller operation.

In one embodiment, controlling output of the at least one game element for electronic game presentation includes outputting personalized game content based on the user profile.

According to another embodiment, a device is provided for electronic game control with electromyography (EMG) sensing and user identification. The device includes an interface configured to receive output from at least one electromyography (EMG) sensor, a memory storing executable instructions, and a controller coupled to the interface and the memory. The controller is configured to receive output from at least one electromyography (EMG) sensor for a user of an electronic game, the output including at least one EMG signal detected from the user, and identify a user profile for the user using the at least one EMG signal detected from the user. The controller is further configured to control output of an electronic game presentation, wherein at least one game element of the electronic game is configured for output using the user profile.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1A is a graphical representation of a system for electronic game control with electromyography (EMG) sensing and user identification according to one or more embodiments;

FIG. 1B is a graphical representation of a controller configuration with an EMG sensing wrist strap for electronic game control and user identification according to one or more embodiments;

FIG. 2 illustrates a process for electronic game control with EMG sensing and user identification according to one or more embodiments;

FIG. 3 illustrates a device configuration according to one or more embodiments;

FIGS. 4A-4B are graphical representations of EMG signals according to one or more embodiments; and

FIG. 5 is a graphical representation of machine learning operations according to one or more embodiments.

### DETAILED DESCRIPTION OF THE EXEMPLARY EMBODIMENTS

### Overview and Terminology

One aspect of the disclosure is directed to systems and methods for electronic game control. According to embodiments, electronic game control may include operations for one or more of a gaming console, interactive entertainment device, game controller and one or more network devices for controlling presentation of electronic gaming content. Embodiments are provided using one or more electromyography (EMG) sensors and operations to utilize sensor output within gaming device operations and user identification. EMG sensors and operations are provided for control interfaces of interactive entertainment devices. While embodiments are discussed herein with respect to control of electronic game content and interactive entertainment, it should be appreciated that the principles of the disclosure are not limited to electronic games and may be applied to other applications. Embodiments may be applied to virtual reality (VR) and augmented reality (AR) systems for gaming and non-gaming applications.

Gaming systems may include consoles or devices that play game media, consoles that provide network data for games, handheld devices, mobile devices (e.g., tablets, mobile phones, etc.) and devices in general configured for electronic gaming. Gaming systems may be applications on mobile devices and tablets. Gaming systems and devices may also receive controls and interact with users by way of control devices, such as game controllers.

According to embodiments, output from one or more EMG sensors may be employed for user identification. Different users may have different levels of EMG output, accordingly one or more of signal peak, frequency and wave shape may be used as characteristics for assessing EMG output. In addition to EMG signals detected for a user, embodiments can include detecting users based on recorded/stored EMG data and EMG sensor output for one or more use actions. User actions may be prompted, such as a control device generating one or more of a display, audio output and haptic output to a user. User actions may be detected based on use of one or more input controls. According to other embodiments, user actions may be detected for a series of user actions detected in a predetermined time. Systems and embodiments described herein can detect user actions, store EMG signals for the user actions and then allow a user to provide the user actions to unlock and/or control device operations. User actions can include a series of hand gestures, controller inputs (e.g., button presses, directions, etc.) and/or a combination of hand (e.g., wrist finger, hand, etc.) and controller inputs. EMG data detected for a user may be stored with a user profile, the user profile providing one or more data fields and parameters that may be used for control of an electronic game. The user profile may store one or more user code patterns including one or more of user hand, finger or wrist motions. The user profile may store a user code including a combination of EMG signals and controller inputs. The user profile may also store one more recorded signatures of a user and associated with one or more user inputs to a game controller.

Game control may be provided for devices, such as gaming consoles, interactive entertainment devices, displays with control interfaces, handheld gaming units and network devices including gaming servers. Modern gaming applications can provide high quality graphic output and utilize data bandwidths for one or more users. Embodiments are directed to identification of a user to allow for customization and configuration of one or more games based on the user identified. User identification may relate to identification of a user profile. Embodiments may also use EMG sensor output to aid in detection of user controller inputs. Embodiments provide configurations and operations to detect and use user EMG signals to reduce latency of operations.

Systems and methods are provided for electronic game control with EMG sensing and user identification. EMG signals of a user may be detected and used to identify one or more users from electrical activity, that is the EMG signals to user muscles. By sensing EMG activity, signals may be provided to a game controller, such as one or more of a console, and network device. Detected EMG signals may be used to identify a user and may be used to provide gaming content in advance of detection of a button press or user activation on a user controller. By detecting EMG activity, indications of user control may be provided earlier in time and latency of device operation may be reduced. By identifying a user, one or operations and features for login and our acceptance of user feedback may be eliminated. Similarly, user identification may allow for game presentation to be presented for a particular user taking into account previous game sessions, progress in a game, game features available for a user and access to a game system.

Embodiments are directed to configurations for game controllers (e.g., handheld controls, etc.) and control devices. Game controller embodiments include configurations for use and/or interoperation with EMG sensors, EMG sensor and controller connection, and game controller operation. According to embodiments, EMG sensors may be retained and/or provided by a strap or other wearable element to detect user activity. Game controller configurations may provide assistance for interactive entertainment including gaming devices, gaming consoles, virtual reality, and augmented reality systems using controllers.

Systems and methods for electronic game control and game controller configurations with EMG sensing may include operations for controlling signal detection. Embodiments include operations for at least one of training and using machine learning models for detection and identification of user EMG control signals and users. EMG signals may be used for one or more control inputs of a game controller, including touch sensitive inputs, such as touch pads. Controller configurations may include one or more operations for reconciliation of latency in game controller commands at the controller and by a device controlling presentation of a game. EMG signals may enhance the control of touch pads and may be used to improve the accessibility of control devices.

Although device configurations, systems and processes are discussed with respect to gaming applications and interactive entertainment, it should be appreciated that the principles of the disclosure may be applied to network control devices and input devices in general.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

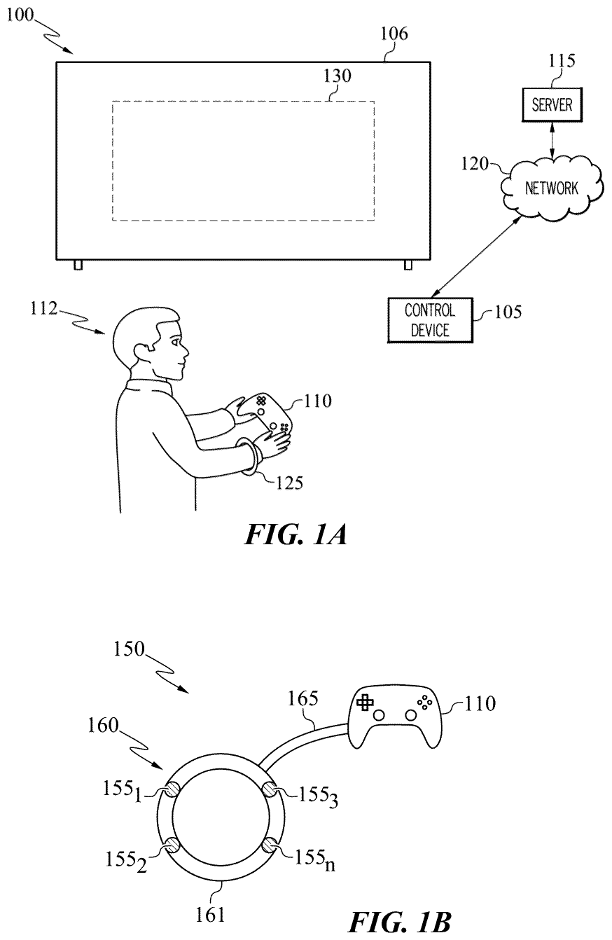

FIG. 1A is a graphical representation of a system for electronic game control with electromyography (EMG) sensing and user identification according to one or more embodiments. System 100 is configured for detecting and using one or more electromyography (EMG) sensors and operations to utilize sensor output in association with gaming device operations (e.g., electronic games, virtual reality, augmented reality, online gaming, video games, interactive entertainment, etc.). EMG signals may be detected for a user and used for device control and detection of user identify. System 100 may be configured for control of electronic game content and interactive entertainment including applications for virtual reality (VR) and augmented reality (AR) systems for gaming and non-gaming applications. According to embodiments, one or more devices of system 100 may be configured for electronic game control with EMG sensing and processing.

System 100 includes control device 105 which may be configured to control electronic game content presentation on display 106. Control device 105 may be a gaming device configured to output and control output of gaming content to display 106 including at least one of audio and video data. Control device 105 may be configured to receive controls for presentation of content from game controller 110. Game controller 110 may include one or more inputs for user activation or control and may be operated by a user, such as user 112. Control device 105 may communicate with at least one server, such as server 115 by way of network 120. According to embodiments, one or more of control device 105 and server 115 may identify user 112 based on EMG signals detected.

According to embodiments, at least one device of system 100 may be configured to use output of at least one EMG sensor for control of electronic game presentation. Detected EMG signals may be used to generate communications relative to devices. Similar to a control input communication (e.g., button press on a game controller, directional command, etc.) that is communicated to a gaming device, EMG signals may be detected and communicated in system 100. One advantage of EMG signals over game controller signals (e.g., button press) may be the time of detection and availability of detection before a game controller command is detected. Communication of EMG signals to control devices and game services can improve the latency of device operation by providing the signals to a control device before a button press or other controller command is detected.

According to embodiments, user EMG signals may be detected and monitored, with user permission, during presentation of an electronic game and interactive media in general. According to embodiments, control device 105 may relate to a media output device, such as a game console. It should be appreciated that one or more of server 115 and display device 106 may be configured to provide electronic game functions, game control and interactive media output. It should also be appreciated that detection of a user EMG signals and controller inputs is not limited to electronic games. The principles of the disclosure may be applied to other forms of network and interactive device control in general. For purposes of illustration and example of operation, system 100 and control device 105 may detect user EMG signals for users during presentation of electronic game content by display 106. Users may be controlling an electronic game output by control device 105.

According to embodiments, EMG signals may be detected from the body of a user, such as user 112, by way of at least on EMG sensor. An EMG sensor device may include a plurality of EMG sensors. For example, EMG sensor devices may include a plurality of sensors in a wearable element, such as a band or strap. According to embodiments, an EMG sensor device may be worn and/or placed on a user, such as a user's wrist, to detect electrical activity associated with user control of one or more of fingers, hands and wrists. FIG. 1A illustrates EMG sensor device 125 configured to detect EMG signals for user 112 and communicate EMG output to game controller 110. According to embodiments, controller 110 may receive EMG output from one or more EMG sensor devices, such as EMG sensor device 125. EMG sensor device 125 may include one or more EMG sensors. According to embodiments, EMG sensor device 125 may be electrically coupled to controller 110 and may receive power from controller 110. EMG sensor device 125 may include a physical element or structure, such as a strap or band, to tether to controller 110. The strap may be a textile such that EMG sensors may be provided by one or more of wires, flat electrodes, grid electrodes, and other forms of electrodes embedded in the substrate of the strap or band. EMG sensor device 125 may be part of a wearable device, such as a smartwatch. According to embodiments, FIG. 1A illustrates game controller 110 as a two-handed controller. It should be appreciated that embodiments may be applied to other controller types and configurations, such as two one handed controllers, wherein each one handed controller would be connected to a strap around the wrists of the users and EMG signals from each strap are detected and used by a control device 105.

Processes and device configurations are described herein for detection and use of output of EMG sensor device 125 for user identification and for game control. By way of example, embodiments include controller 110 configured to receive output of at least one of EMG sensor device 125, and detection of EMG user controls signal for user 112. The EMG user control signals may be an EMG signature, EMG sensor data output, signal attribute and/or identifier indicating a user command and/or user motion. The EMG user control signal may be associated with operations of controller 110. For example, a user may generate electrical activity for control of the user muscles to control their movement, including wrist, hand or fingers to activate an input of a controller. EMG sensor device 125 may detect the electrical activity prior to the actual input of a controller. According to embodiments, controller 110 may communicate the EMG signals to one or more of control device 105 and server 115 by way of network 120 for control of electronic game presentation, such as controlling gaming data generally shown as 130. EMG control signals may be detected for user movement, including hand, wrist and/or fingers separate from controller 110. EMG control signals may be detected for a user performing a series of movements that are intentional or unintentional. For example a user may periodically or repeatedly make movements such as a twitch or habitual movement. These movements may be detected in associated with a user grabbing a controller. According to embodiments, a user may make a series of gestures or movements, wherein detection of the series of user movements may be detected for a period of time. In certain embodiments, the series of user movements may be recorded as a form of a user password or signature. For example a user may rotate a wrist fully, make a two-fingered peace sign followed by thumbs up on a single hand as an example of a use gesture or sequence to notify a device of a user. Based on the sequence and user movements, a device may identify the user and a user profile associated with the user.

According to embodiments, system 100 may be configured for electronic game control and user identification with EMG sensing using a plurality of EMG sensors in a strap and a controller. For example, game controller 110 may be configured to interface with at least one strap including at least one electromyography (EMG) sensor. Game controller 110 may include a game controller body (e.g., housing, structure, etc.) supporting at least one input control. Game controller 110 may also include a controller (e.g., processor, etc.) housed in the game controller body electrically coupled to the at least one input control. The controller of game controller 110 is configured to receive output of at least one electromyography (EMG) sensor, such as EMG sensor device 125, for a user of an electronic game. Output of the EMG sensor devices may include at least one EMG signal for the user. The controller of game controller 110 is also configured to detect an EMG user control signal in the at least one EMG signal for the user. The controller of game controller 110 is also configured to output the EMG user control signal for control of electronic game presentation to the gaming device. The controller of game controller 110 may be configured detect a user profile. According to embodiments, a user may be identified based on output of a plurality of EMG sensor devices. For example, output from EMG sensor device 125 may be used for detection and/or user identification using input from each sensor device. For example a user login or password may be detected from motion of a first user hand detected by EMG sensor device 125. According to embodiments, motion from a second user hand may be detected by a second EMG sensor device. A user login may include a user hand gesture on a first hand, followed by one or more additional hand gestures. User login codes may be detected for a series of hand gestures, wherein the hand gestures are generated by one or more EMG sensors.

A strap configuration is discussed in FIG. 1B which may include one or more EMG sensors. Game controller 110 may interoperate with a strap configuration according to embodiments. Control device 105 may be a gaming device configured to control presentation of electronic game data including generating game data for a first game state based on the user control signal detected in the at least one EMG signal for the user. The gaming device may also be configured to generate game data for a second game state in response to the user control signal and expiration of a user controller activation window. By way of example, control device 105 may generate or process multiple game states or functions in response to EMG data. By pre-processing or processing additional game states, control device 105 may reduce the latency of processing game data or game processing to present game content.

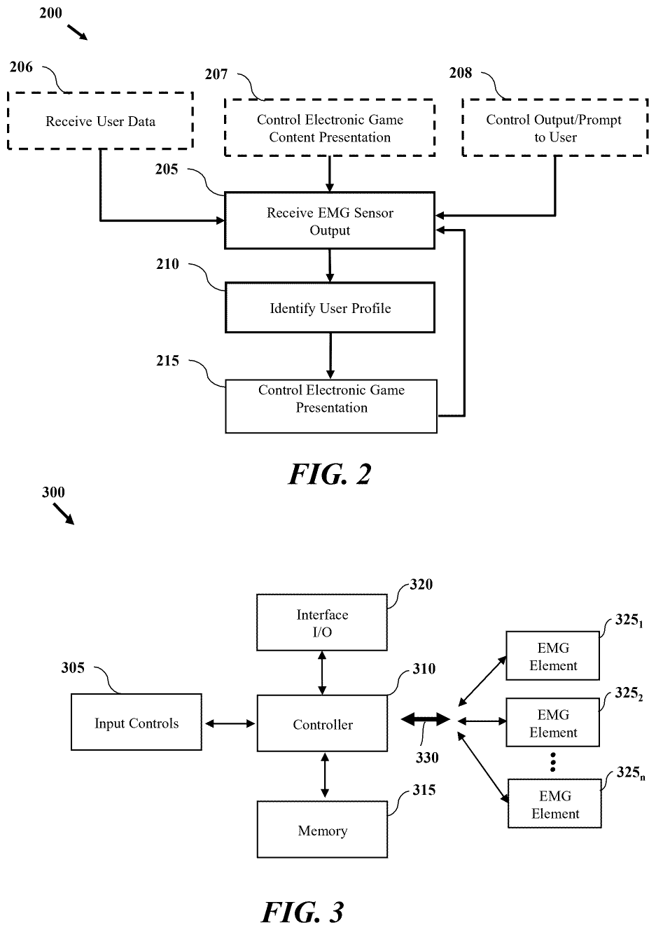

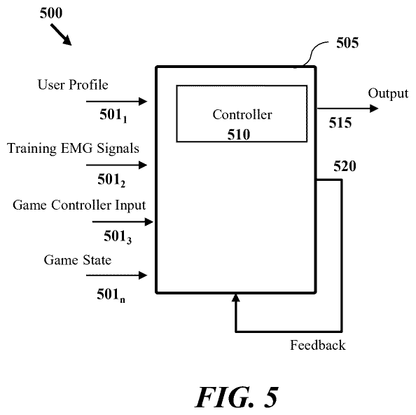

According to embodiments, control device 105 may be a standalone device, such as a game console or game media player. Control device 105 may receive user input controls and user EMG data from game controller 110. Control device 105 may communicate user input controls and user EMG data from game controller 110 to server 115 by way of network 120. According to embodiments, control device 105 and display 106 may be parts of the same unit, such as a display device with a processor or a handheld gaming device. Control device 105 may be controlled by one or more game controllers, such as game controller 110. According to embodiments, control device 105, display 106 and game controller 110 may be parts of the same unit, such as a handheld gaming device. FIG. 1A illustrates game content presentation including one or more game elements, such as game element 130. According to embodiments, control device 105 may be configured to control presentation format for the electronic game content based on at least one of user input controls and user EMG data from game controller 110. According to embodiments, user input controls and user EMG data from game controller 110 may each include signals for controlling position of a user controlled object, making a selection, or providing an input command in general. Processes for identification of EMG controls are discussed with reference to FIGS. 2 and 5. According to embodiments, system 100 may be configured to use and update machine learning models. Based on one or more user EMG signals, control device 105 may be configured to control a presentation format and the electronic game content. According to embodiments, EMG signals and one or more user profiles detected form EMG signals can be used to control operations for electronic game content presentation. According to embodiments, control device 105 may be configured to perform one or more network operations including communicating with one or more servers on a communication network. Network operations can include providing one or more EMG signals for one or more users associated with a game session.

System 100 may provide features to improve user experience, wherein functions and operations described herein are performed following user consent, with express notice to a user, and/or in alignment with one or more user settings for user privacy. By way of example, detection and/or use of EMG signals may be in response to and based on user consent. It should be appreciated that embodiments may be applied to interactive entertainment with one or more users. Processes described herein are not limited to gaming content and detection of EMG signals may be used for interactive control of gaming and non-gaming activities.

FIG. 1B is a graphical representation of a controller configuration with an EMG sensing wrist strap for electronic game control and user identification according to one or more embodiments. According to embodiments, game controller configuration 150 is provided including game controller 110 and EMG sensor device 160. Game controller configuration 150 may operate with a system, such as system 100, or one or more devices for control of electronic gaming content or interactive entertainment. EMG sensor device 160 may include one or more EMG sensors, such as EMG sensors 155₁₋ₙ. EMG sensor device 160 may be an exemplary structure of EMG sensor device 125. EMG sensor device 160 may be electrically coupled to controller 110 and may receive power from controller 110, by way of cable 165. EMG sensor device 160 may include one or more structural elements, such as a strap or band and tether to controller 110 to secure the controller to a user.

According to embodiments, EMG sensor device 160 may include a structural element 161 supporting EMG sensors 155₁₋ₙ. Structural element 161 may be a strap, band, tether or manufactured element including at least one electromyography (EMG) sensor. Structural element 161 may include one or more elements to form a band or material for engaging with a portion of a user, such as a user's wrist. EMG sensor device 160 may be coupled to a body of game controller 110. Structural element 161 may be a strap coupled to the game controller body, the strap including at least one electrical connection for each of the EMG sensor elements and an interface of the game controller body. Cable 165 may include connections for signals and data for EMG sensors 155₁₋ₙ to connect to a controller housed in game controller 110. According to embodiments, structural unit 161 and cable 165 may be formed of one or more materials in a joint fashion, such as a strap including EMG sensors 155₁₋ₙ and electrical connections. According to embodiments, EMG sensors 155₁₋ₙ include a plurality of EMG sensor elements retained by structural element 161. The output of EMG sensors 155₁₋ₙ can include electrical activity detected from a user wrist and associated with at least one of a hand movement and finger movement of a user. The output of EMG sensors 155₁₋ₙ can include electrical activity associated with user EMG data for at least one of a button press, directional pad input, analog stick motion, finger gesture, wrist motion, and controller movement. Detecting a user control signal can include correlating at least a portion of the EMG signal to recorded EMG data for a user game controller action. Detecting a user control signal can include using a machine learning model to detect and identify the user control signal from the EMG signal.

According to embodiments, EMG sensor device 160 may be configured with EMG sensors 155₁₋ₙ built into a stretchable elastic wristband that directly plugs into a controller (e.g., a XR (AR/VR/MR) controller). EMG sensors 155₁₋ₙ may be configured to measure the electrical activity of the user's muscles in the wrist as they move their hand and fingers. The electrical signals may be converted to a digital data stream and fed to controller 110 along the attached wire that plugs into controller 110. Power for EMG sensors 155₁₋ₙ may be provided by controller 110. By controller 110 providing power, a wrist strap may be provided in a light weight and thin structure. A stretchable elastic wristband may safely secure controller 110 to a user, such that if the user accidentally loosens their grip on the controller, it will not fall and break or fly out of their hand during gameplay and cause damage. EMG sensors 155₁₋ₙ may be configured to automatically learn a user's own (potentially unique) muscle electrical activity when playing a game. The muscle signals may be indicative of one or more of button presses, including trigger and grip buttons, analog stick movement, touching and moving a finger over a touchpad, finger gestures, wrist motion and controller movement. In combination with the actual button presses, analog stick motion, touch inputs, capacitive sensing of finger gestures and six degree of freedom (e.g., 6 DOF) pose from controller 110, muscle activity may be determined a period of time (e.g., 1-3 milliseconds) prior to the user's intended action. By way of example, a user pressing a button on a controller may be detected based on one or more electrical signals or pulses that travel to a user's hand (e.g., electrical pulses from a user brain). The electrical signals of the hand and finger motion may be detected in the wrist strap. EMG data may be captured in time series prior to actual detection of the game controller detecting the movement. One or more of EMG signals and controller inputs may be used to trigger a learning process.

According to embodiments, EMG sensor device 160 may include a plurality of EMG sensor elements retained by structural element 161 which may be coupled to a body of game controller 160. The structural element 161, configured as a strap or band, can include at least one electrical connection for each of the EMG sensor elements and an interface of the game controller body. Structural element 161 may include one or more fibers or elements woven or assembled to retain EMG sensors 155₁₋ₙ.

According to embodiments, the structural element 161, configured as a strap or band, can include additional sensors, such as electrocardiogram (ECG) sensors, optical reflectance photoplethysmography (PPG) sensors, or other types of sensors to measure a user's heart rate and other user biometrics like blood oxygen level. According to embodiments, the structural element 161, configured as a strap or band, can include additional elements for fitting, including hook and loop fastener sections, a clasp mechanism, or other types of adjustment mechanisms to allow the structural element 161 to be resized to fit various diameters of user wrists. Structural element 160 can perform multiple functions including at least one of hosting various sensors in close proximity to a user, and to securely fit on a user's wrist, such that cable 165 attached between the structural element 160 and game controller 110 prevents the user from dropping or throwing game controller 110. Cable 165 may be configured to provide electrical power between game controller 110 and the sensors 1551-n, to provide data signaling between sensors 1551-n and game controller 110, and to prevent game controller 110 from being dropped or thrown, when the user is no longer holding the controller.

According to embodiments, game controller configuration 150 is provided including game controller 110 and EMG sensor device 160. Game controller configuration 150 may operate with a system, such as system 100, or one or more devices for control of electronic gaming content or interactive entertainment. EMG sensor device 160 may include one or more EMG sensors, such as EMG sensors 155₁₋ₙ. According to embodiments, game controller configuration 150 may be configured to detect user activation of a game controller after detecting the EMG user control signal and to generate controller output based on the user activation. According to another embodiment, output of a user control signal by game controller configuration 150 can include output of the user control signal to a game controller of control device 105 prior to generating and/or outputting output of controller 110 based on the user activation. Put another way, the EMG signals may be output prior to and/or independently from actual user inputs to controller 110. Commands and input based on user activation of game controller 160 may be output to controller 110.

According to embodiments, game controller configuration 150 may be configured to detect a user control signal including correlating at least a portion of the EMG signal to recorded EMG data for a user game controller action. User EMG signals may be detected and used to train or identify a user's EMG profile for controller actions. EMG data and controller output may be mapped to identify one or more EMG profiles or signatures that correlate to actual user input controls for one or more users. According to embodiments, detection of the user control signal may include using a machine learning model to detect and identify the user control signal from the EMG signal. Game controller 110 may be configured to perform one or more operations for learning, such as self-learning, of EMG signals received from EMG sensor device 160 to determine if EMG signals indicate a controller input and if EMG signals should be communicated. According to embodiments, game controller configuration 150 may be configured to detect a user movements including correlating at least a portion of the EMG signal to recorded EMG data for user actions, such as user login, user passcode, user motion commands and hand user gestures. User EMG signals may be detected and used to train or identify a user's profile, including one or more of a user EMG profile for user identification.

FIG. 2 illustrates a process for electronic game control with EMG sensing and user identification according to one or more embodiments. Process 200 may allow for use of EMG data detected by an EMG sensor device (e.g., EMG sensor device 160, EMG sensors 155₁₋ₙ, etc.) for electronic game control with electromyography (EMG) sensing and user identification. Process 200 may be performed by a device, such as one or more of control device 105, controller 110, server 115, device 300 and/or controller 310 of FIG. 3. Process 200 may be utilized for a system, such as the system of FIG. 1 discussed herein.

Process 200 may be initiated by a device receiving output of at least one electromyography (EMG) sensor for a user of a device, such as a user of an electronic game console or media player, at block 205. According to embodiments, EMG signals received at block 205 may be detected by at least one EMG sensor of an EMG sensor device (e.g., EMG sensors 155₁₋ₙ of EMG sensor device 160) for a user (e.g., person). When process 200 is performed by an EMG sensor device, EMG signals may be detected at block 205. EMG signals may be detected continuously or at one or more time intervals for a user and may relate to EMG signals detected by one or more wearable or near-body sensors. The output of the at least one EMG sensor may be output by an EMG device to a game controller to provide at least one signal of electrical activity detected from a user wrist and associated with at least one of a hand movement and finger movement of a user. The output can include output of the at least one EMG sensor including electrical activity associated with user EMG data for at least one of a button press, directional pad input, analog stick motion, finger gesture, wrist motion, hand gesture, series of user gestures, user movements and controller movement.

Process 200 may optionally include receiving user data at optional block 206. According to embodiments, user data, including user profiles, may be received for one or more users. User profiles may include data for a user such as a user name, access rights to game content, user preferences and user data in general. User profiles may also include user data including user settings, user EMG data references and user EMG data for sequences associated with a user login and/or user identification sequence. User data may be received to include one or more signatures or samples of user EMG data for one or more controller commands. In certain embodiments, user data received at block 206 includes one or more of a user profile and user identification. Users may be identified to assist with processing of one or more user EMG signals.

Process 200 may optionally include controlling electronic game presentation at optional block 207. Control of electronic game presentation can include controlling one or more game elements and game functions in response to one or more input controls, including inputs to game controller 110, shown in game controller configuration 150, and/or user profiles identified. Output of control signals at block 215 may be for game content presented by a control device. Electronic game control at block 207 may include control of one or more game menus, and/or control during game play. According to embodiments, process 200 may optionally include controlling output and/or prompts to a user at block 208. Output at block 208 may be to request a user login and/or identification. Output at block 208 may be in the form of an audio, graphical, haptic, video or combination of any of the aforementioned outputs.

At block 210, process 200 includes identifying a user profile for the user using the at least one EMG signal detected from the user. According to embodiments, output from one or more EMG sensors may be employed for user identification. Different users may have different levels of EMG output, accordingly one or more of signal peak, frequency and wave shape may be used as characteristics for assessing EMG output. In addition to EMG signals detected for a user, embodiments can include detecting users based on recorded/stored EMG data and EMG sensor output for one or more use actions. User actions may be prompted, such as a control device generating one or more of a display, audio output and haptic output to a user. User actions may be detected based on use of one or more input controls. According to other embodiments, user actions may be detected for a series of user actions detected in a predetermined time. Systems and embodiments described herein can detect user actions, store EMG for the user actions and then allow a user to provide the user actions to unlock and/or control device operations. User actions can include a series of hand gestures, controller inputs (e.g., button presses, directions, etc.) and/or a combination of hand (e.g., wrist finger, hand, etc.) and controller inputs. EMG data detected for a user may be stored with a user profile, the user profile providing one or more data fields and parameters that may be used for control of an electronic game. The user profile may store one or more user code patterns including one or more of user hand, finger or wrist motions. The user profile may store a user code including a combination of EMG signals and controller inputs. The user profile may also store one more recorded signatures of a user and associated with one or more user inputs to an input controller.

At block 210, process 200 includes identifying a user profile including outputting a prompt for a user movement and detecting a user data signature in the output of the at least one EMG sensor in response to the prompt. According to embodiments, identifying the user profile at block 210 may include detecting a user login for a game console using output of the at least one EMG sensor. Identification of the user profile at block 210 may be based on a prompt generated at block 208. The user profile may include at least one of a user login, user profile data and user defined game setting. Identifying a user profile at block 210 may include detecting a plurality of user movements in the output of the at least one EMG sensor, the plurality of user movements performed with a predefined sequence. Identifying the user profile at block 210 may include comparing of the output of the at least one EMG sensor to recorded EMG sensor data for the user.

At block 215, process 200 includes controlling output of an electronic game presentation. Controlling output of electronic game presentation may include configuring at least one game element of the electronic game for output using the user profile. For example, controlling output of the at least one game element for electronic game presentation can include unlocking at least one of a game feature and game controller operation. Controlling output of the at least one game element for electronic game presentation can include outputting personalized game content based on the user profile.

At block 215, process 200 may include detecting an EMG user control signal in the at least one EMG signal for the user. Detecting a user control signal can include correlating at least a portion of the EMG signal to recorded EMG data for a user game controller action. Detection of user control signals may be based on user data for one or more game sessions and game controller actions. Control devices may be configured to detect EMG data and controller signals and correlate one or more signatures, signal profiles, samples and EMG peaks with controller actions.

At block 215, process 200 may include outputting the EMG user control signal for control of electronic game presentation. User control signals may be output to a game control device (e.g., control device 105). Output of the EMG user control signals may be output independently of user inputs to a game controller. According to embodiments, output of the EMG signals may be provided to a game controller prior to actual game controller outputs. By providing EMG signals to a control device first, and prior to output of controller inputs (e.g., button presses, directional pad inputs, analog stick inputs, etc.) a game controller may receive input commands at an earlier time. Processing abilities of a game control device may be configured to control game operations or process game functions at an earlier time. As such, game lag may be reduced by providing a means for a game controller to communicate incoming game controls. In addition, reduction of game lag may improve game performance to improve presentation speed of visible actions performed for game streaming from a cloud network and for games in virtual reality (VR) or augmented reality (AR).

Process 200 may include receiving additional EMG sensor output at block 205 following control of an electronic game presentation at block 215. According to embodiments, EMG sensor data may be detected and user after a user profile is detected.

FIG. 3 illustrates a device configuration according to one or more embodiments. Device 300 may relate to a game controller configuration (e.g., game controller configuration 150). Device 300 may be include a game controller for electronic games or a gaming console controller. According to embodiments, device 300 may include one or more EMG sensor elements. According to embodiments, device 300 may interface with one or more EMG sensor elements. Device 300 may be configured to detect, receive and/or output one or more EMG signals to a control device, such as a game console or network game controller. According to embodiments, device 300 includes input controls 305, controller 310, and memory 315. Device 300 may also include interface (e.g., Input output (I/O)) 320, and EMG sensor elements 325₁₋ₙ.

Controller 310 may relate to a processor or control device configured to execute one or more operations stored in memory 315, such as processes for electronic game control with electromyography (EMG) sensing and processing EMG signals of EMG elements 325₁₋ₙ. Controller 310 may be coupled to input controls 305, memory 315, interface 320, and EMG elements 325₁₋ₙ. Memory 315 may be non-transitory memory configured to provide data storage and working memory operations for device 300. Memory 315 may be configured to store computer readable instructions for execution by controller 310 for one or more processes described herein. Interface 320 may be a communications module configured to receive and transmit data relative to device 300.

EMG elements 325₁₋ₙ of device 300 may be configured to detect user signals, such as electrical currents generated in muscles and/or human tissue representing neuromuscular activities. EMG elements 325₁₋ₙ may be configured to output one or more signals characterizing user activity and user movements, including one or more signals representing activity of a user's nervous system. EMG signals may be received and one or more control signals may be detected by controller 310 for at least one of a game controller input. Controller 310 may be configured to detect and/or communicate EMG signals to one or more devices, such as a gaming console or interactive entertainment device, for game control (e.g., control device 105). Device 300 may also include electrical coupling 330 which may include one or more cables, wires, and bus elements to provide at least one of data and power relative to controller 310 and EMG sensor elements 325₁₋ₙ. Electrical coupling 330 may be housed and/or integrated with EMG sensor structure.

According to embodiments, the EMG sensor elements 325₁₋ₙ may be configured to spatially capture surface electromyography (sEMG) signals around the circumference of a user's wrist, with monopolar or bipolar dry electrodes evenly distributed around the circumference as shown in FIG. 1B. In other embodiments, the distribution of the electrodes could be biased, such that they reside mostly next to the underside of a user's wrist.

FIG. 3 depicts a device configuration according to embodiments. Device 300 may relate to gaming controller and gaming input device in general. Device 300 may also include one or more interactive controls that communicate with a base device in general.

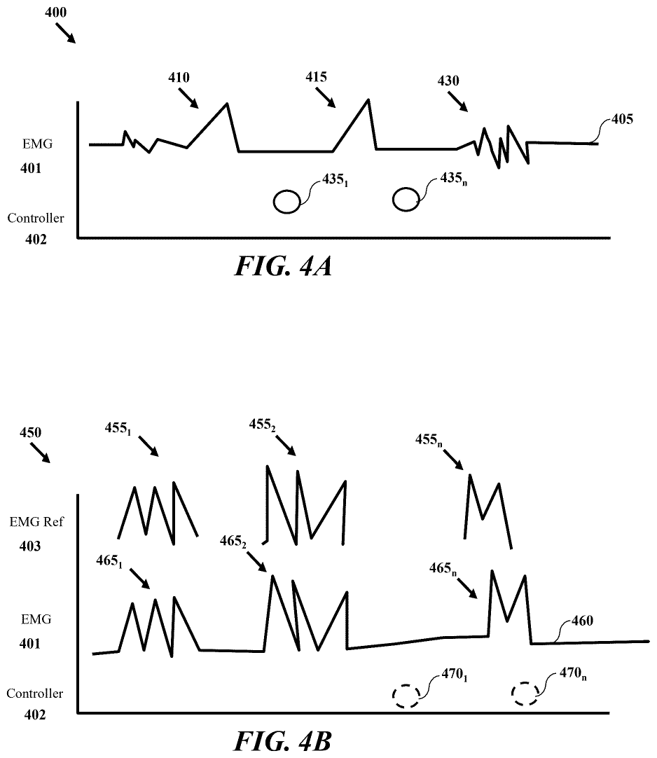

FIGS. 4A-4B are graphical representations of EMG signals according to one or more embodiments. FIG. 4A is a graphical representation of an EMG signal and controller input in time series according to one or more embodiments. According to embodiment, at least one of game controller (e.g., game controller 110) inputs and EMG sensor output (e.g., EMG sensors 155₁₋ₙ) may be used to control electronic game presentation. Control data 400 includes EMG signal data 401 and controller input data 402. EMG signal data 401 may relate to output of one or more EMG sensors (e.g., EMG sensors 155₁₋ₙ) detected for a user during electronic gameplay. Controller input data 402 represents game inputs to a game controller (e.g., game controller 110). Users may hold a game controller and activate the game controller through one or more of controller movement, activation of controller inputs (e.g., directional pad movement, button press, analog stick motion, surface commands, taps, slides, etc.). A user may not be aware or feel internal electrical signals sent from a user's brain to user muscles to activate a controller. According to embodiments, one or more EMG sensors may be worn or placed in proximity to one or more portions of a user's body to detect electrical stimuli for muscle control including EMG signals of a user in connection a with controller activation. EMG data 401 includes detected EMG signal 405 including peaks 410, 415 and signal profile 430. Peaks 410 and 415 may be indicative of a user EMG signal to activate a game controller, such as a button press. Peaks 410 and 415 may be indicative of muscle tightening that is detected to read prior to control inputs, such as 5 ms-150 ms delay between EMG signal and controller input. It should be appreciated that peaks 410 and 415 are exemplary and that user EMG control signals may include one or more of an EMG peak, time signature, and signal pattern. It should be noted, that based on numerous medical studies, neuro-electrical signals from the brain to instigate finger motion have been measured to take between 3-4 ms (milliseconds) from the wrist area to digit motion. The time period from the wrist area to digit motion may be a minimal latency reference for the onset of finger motion. This latency period does not include the time for finger travel, as well any controller button or other controller sensor physical travel/delay before an electrical signal is generated from the sensed controller input. Therefore, wrist-to-controller input latencies can be from 5 ms or typically more depending on the user, the controller input and its physical travel/delay before signal generation. It should be understood, that determining controller inputs via an EMG sensing wrist strap at least 5 ms before an actual controller input is detected can greatly contribute to the reduction in overall latency for the inputs to a gaming system, especially a network streaming based gaming system.

According to embodiments, peaks 410 and 415 may be detected and correlated to user game controls. One or more processes including machine learning processes may be used to identify EMG user control signals such as peaks 410 and 415 relating to a user control. Controller data 402 includes detection of a controller actions 435₁₋ₙ which correspond to peaks 410 and 415. According to embodiments, when an EMG signal or signal profile is detected of an action that precedes a controller command or is indicative of a controller command, such as peaks 410 and 415 preceding controller commands 435₁₋ₙ, a control device may communicate the detection of the EMG user control signals to one or more devices for controlling presentation of gaming content. According to embodiments, communication of an EMG user control signals for detected peaks 410 and/or 415 may be output prior to detection of controller data 402. According to embodiments, EMG data 401 may be filtered to remove EMG signals not indicative of a game controller signal. Embodiments can include filtering of EMG data, such as signal profile 430.

According to embodiments, a machine learning process, for example a supervised reinforcement learning process, may utilize one or more channels of EMG user control signal data within a sampling time window to filter and correlate characteristics around signal peaks associated with finger, palm, and wrist muscle activity. For example, peaks 410 and 415 may contain uniquely identifiable characteristics before and after their peak signal, including a typical range of rising slope lengths, as the number of rising signal values from a low threshold value to the peak value and/or a typical range of falling slope lengths, as the number of falling signal values from the peak value to a low threshold value.

According to embodiments, EMG data 401 may include one or more detected EMG signals, such as EMG signal 405, as input for machine learning operations. The machine learning operations may include statistical or recursive operations to correlate one or more previous EMG time series or data prior to a button press. From detecting repeated actions of a user, such as a user pressing the same button, a signal filter can be derived to isolate the specific EMG signal spikes that correlate to the user's finger pressing the button. After one or more training sessions, which may be performed in the background while a user plays a game (e.g., no specific training period allocated required), a filter may be used to detect user input, such as a user's finger button pushing intent a few milliseconds before a button is pressed. Once this intent is recognized, the action for the button is sent to the server running the game, to prepare the result of the action sooner than before. Using the above processing, a controller with EMG sensors or a wrist strap can learn to reduce the latency of user inputs over time and help a game streaming over a network appear to reduce the latency of user's actions within a game, such that it appears the game is running locally on a console or PC within the home. It should be understood, that a general model (e.g., a collection of previously learned EMG signals to user input filters) may be created ahead of time and available in the system to all players, so that streaming games appear to have lower latency immediately. It should be also understood, that each user's EMG signals and the way they wear the wrist strip, will be different, so the general model will only provide a baseline solution. As each user plays games, the general model learns to become a personalized EMG signal to intent model and that is stored with the user's login data, such that it is retrieved every time the user logs into the system to play games. In addition, all personalized EMG signals to user intent models from many users can be collated and a better general model can be derived. With the above described system, the average input latencies within streaming games will gradually reduce as many users play games.

FIG. 4B is a graphical representation of an EMG signal and controller input in time series according to one or more embodiments. According to embodiment, at least one of game controller (e.g., game controller 110) inputs and EMG sensor output (e.g., EMG sensors 155₁₋ₙ) may be used to control electronic game presentation and for user identification. Control data 450 may include EMG signal data 401, controller input data 402 and EMG reference data 403. EMG signal data 401 may relate to output of one or more EMG sensors (e.g., EMG sensors 155₁₋ₙ) detected for a user. Controller input data 402 represents game inputs to a game controller (e.g., game controller 110). EMG data 401 in FIG. 4B includes detected EMG signal 460 including peaks 465₁₋ₙ which may represent data detected from a user provided a predefined user input pattern. For example, systems, devices and processes descried herein may be configured to detect EMG signals for a user input pattern of hand, wrist and/or finger motions. References may be captured for the user motions, such as EMG reference data 403. According to embodiments, EMG data representative of the user's EMG signals for the motions may be captured and used as references, such as EMG references 455₁₋ₙ. EMG references 455₁₋ₙ may be indicative of user EMG signals associated with user actions for a user login sequence. Processes described herein may be configured to detect EMG references 455₁₋ₙ in user EMG data 401 having peaks 465₁₋ₙ. It should be appreciated that the representation of peaks 465₁₋ₙ are exemplary and that user EMG control signals may include one or more of an EMG peak, time signature, and signal pattern.

According to embodiments, peaks 465₁₋ₙ may be detected and correlated to user game controls including user login and/or user profile selection. One or more processes including machine learning processes may be used to identify EMG user control signals such as peaks 465₁₋ₙ relating to a user control. Controller data 402 includes detection of a controller actions 435₁₋ₙ which correspond to peaks 465₁₋ₙ. According to embodiments, when an EMG signal or signal profile is detected of an action, a control device may communicate the detection of the EMG user control signals to one or more devices for controlling presentation of gaming content. According to embodiments, communication of an EMG user control signals for detected peaks 465₁₋ₙ may be output in addition to and/or independent from controller data 470₁₋ₙ. According to embodiments, EMG data may be filtered to remove EMG signals not indicative of a game controller signal and/or user login/motion input. Embodiments can include filtering of EMG data.

According to embodiments, a machine learning process, for example a supervised reinforcement learning process, may utilize one or more channels of EMG user control signal data within a sampling time window to filter and correlate characteristics around signal peaks associated with finger, palm, and wrist muscle activity. For example, peaks 465₁₋ₙ may contain uniquely identifiable characteristics before and after their peak signal, including a typical range of rising slope lengths, as the number of rising signal values from a low threshold value to the peak value and/or a typical range of falling slope lengths, as the number of falling signal values from the peak value to a low threshold value.

According to embodiments, EMG data 401 may include one or more detected EMG signals, such as EMG signal 460, as input for machine learning operations. The machine learning operations may include statistical or recursive operations to correlate one or more previous EMG time series or data. From detecting repeated actions of a user, such as a user making the same motion, a signal filter can be derived to isolate the specific EMG signal spikes that correlate to the user's EMG references 455₁₋ₙ. After one or more training sessions, which may be performed in the background while a user plays a game (e.g., no specific training period allocated required), a filter may be used to detect user input, such as EMG signal 460. Once this intent is recognized, the action for the user signal may be sent to a server running a game and/or a game controller to control output of the game based on the user EMG signal 460., to prepare the result of the action sooner than before. Using the above processing, a controller

FIG. 5 is a graphical representation of machine learning operations according to one or more embodiments. Process 500 may be performed for training a model for electronic game control with EMG signals according to one or more embodiments. Training process 500 can include receiving training parameters 501₁₋ₙ as training input by a device 505 including a controller 510. According to embodiments, controller 510 may receive a plurality of forms of player input controls and EMG samples as training input. In embodiments, training parameters 501₁₋ₙ may include data for user profile 501₁, training EMG signals 501₂, game type/genre 501₃, and game state 501ₙ. User profile 501₁ may provide one or more parameters characterizing a user including user profile entries, and controller type. User profile 501₁ may include one or more signal profiles of user EMG data. Training EMG signals 501₂ may provide examples of EMG signals and identify one or more corresponding controller input commands. Game controller input 501₃ may provide training data regarding commands for a game and EMG signals to game controls including actual player input by way of a game controller sensor inputs. Player input controls may be labeled as examples of user actions for gaming content and for gaming operations, such as user login and gaming control. Game state 501ₙ may relate to one or more parameters or frameworks for permissible game options. Game state 501ₙ may include one or more parameters for a game type/genre. Based on the training in process 500, controller 510 may generate output 515. Output 515 may include one or more game control parameters for controlling a game session. According to embodiments, controller 510 may be configured to generate output 515 based on a recursive loop including training and feedback. Feedback loop 520 may provide information such as adjustments to the machine learned process within controller 510, ratings, and accuracy for output 515. Feedback loop 520 may feedback or ground truth data on actual player inputs to a game controller. According to embodiments, actual player input via a game controller's sensor inputs (not EMG) and may be labelled as a ground truth reference. Labeled data may be including in feedback loop 520.

According to embodiments, training process 500 and controller 510 may be configured to use one or more learning models (e.g., artificial intelligence, iterative models, etc.) to detect and evaluate EMG signals associated with finger, palm, wrist and hand motion data. Training process 500 and controller 510 may use one or more libraries of player inputs and EMG signals as control examples. According to embodiments, output 515 may include output of control signals identifying one or more of EMG signals, user profiles, and game controller actions.

According to embodiments, training process 500 may use a model for human EMG signals and controller functions. The model may also account for user movement patterns. By detecting muscle activation signals in EMG signals, user intentions for control commands may be isolated and separated. A general model may be trained and used to detect one or more of hand gestures, speed of input, and reaction time using EMG data. User movements may be detected for user signs, such as a peace symbol or hand gestures of closed fist to thumbs up, and user movements to identify the user and/or provide user commands. Timing of a thumb going up and capacitance of lowering of a user finger to a capacitive sensor of a game controller may be used for multi-sensor data in case gesture detection is needed. EMG signal detection may be predictive, such that the detection window of input commands may be shifted to allow for earlier indications of user actions.

While this disclosure has been particularly shown and described with references to exemplary embodiments thereof, it will be understood by those skilled in the art that various changes in form and details may be made therein without departing from the scope of the claimed embodiments.

What is claimed is:

1. A method for electronic game control with electromyography (EMG) sensing and user identification, the method comprising:
receiving, by a device, output from at least one electromyography (EMG) sensor for a user of an electronic game, the output including at least one EMG signal detected from the user;
identifying, by the device, a user profile for the user using the at least one EMG signal detected from the user; and
controlling, by the device, output of an electronic game presentation, wherein at least one game element of the electronic game is configured for output using the user profile.

2. The method of claim 1, wherein the output of the at least one EMG sensor includes electrical activity detected from a user wrist and associated with at least one of a hand movement and finger movement of a user.

3. The method of claim 1, wherein the output of the at least one EMG sensor includes electrical activity associated with user EMG data for at least one of a button press, directional pad input, analog stick motion, finger gesture, wrist motion, and controller movement.

4. The method of claim 1, wherein the user profile includes at least one of a user login, user profile data and user defined game setting.

5. The method of claim 1, wherein identifying a user profile includes outputting a prompt for a user movement, and detecting a user data signature in the output of the at least one EMG sensor in response to the prompt.

6. The method of claim 1, wherein identifying a user profile includes detecting a plurality of user movements in the output of the at least one EMG sensor, the plurality of user movements performed with a predefined sequence.

7. The method of claim 1, wherein identifying the user profile includes comparing of the output of the at least one EMG sensor to recorded EMG sensor data for the user.

8. The method of claim 1, wherein identifying the user profile detecting a user login for a game console using output of the at least one EMG sensor.

9. The method of claim 1, wherein controlling output of the at least one game element for electronic game presentation includes unlocking at least one of a game feature and game controller operation.

10. The method of claim 1, wherein controlling output of the at least one game element for electronic game presentation includes outputting personalized game content based on the user profile.

11. A device configured for electronic game control with electromyography (EMG) sensing and user identification, the device comprising:
an interface configured to receive output from at least one electromyography (EMG) sensor;
a memory storing executable instructions; and
a controller coupled to the interface and the memory, wherein the controller is configured to
receive output from at least one electromyography (EMG) sensor for a user of an electronic game, the output including at least one EMG signal detected from the user;
identify a user profile for the user using the at least one EMG signal detected from the user; and
control output of an electronic game presentation, wherein at least one game element of the electronic game is configured for output using the user profile.

12. The device of claim 11, wherein the output of the at least one EMG sensor includes electrical activity detected from a user wrist and associated with at least one of a hand movement and finger movement of a user.

13. The device of claim 11, wherein the output of the at least one EMG sensor includes electrical activity associated with user EMG data for at least one of a button press, directional pad input, analog stick motion, finger gesture, wrist motion, and controller movement.

14. The device of claim 11, wherein the user profile includes at least one of a user login, user profile data and user defined game setting.

15. The device of claim 11, wherein identifying a user profile includes outputting a prompt for a user movement, and detecting a user data signature in the output of the at least one EMG sensor in response to the prompt.

16. The device of claim 11, wherein identifying a user profile includes detecting a plurality of user movements in the output of the at least one EMG sensor, the plurality of user movements performed with a predefined sequence.

17. The device of claim 11, wherein identifying the user profile includes comparing of the output of the at least one EMG sensor to recorded EMG sensor data for the user.

18. The device of claim 11, wherein identifying the user profile detecting a user login for a game console using output of the at least one EMG sensor.

19. The device of claim 11, wherein controlling output of the at least one game element for electronic game presentation includes unlocking at least one of a game feature and game controller operation.

20. The device of claim 11, wherein controlling output of the at least one game element for electronic game presentation includes outputting personalized game content based on the user profile.
